(19) United States
(12) Patent Application Publication
(10) Pub. No.: US 2023/0178286 A1
(43) Pub. Date: Jun. 8, 2023

(54) SURFACE-MOUNT-ASSEMBLY Z-SHAPED PIN

(71) Applicant: Murata Manufacturing Co., Ltd., Nagaokakyo-shi, Kyoto-fu (JP)

(72) Inventor: Lee FRANCIS, Milton Keynes (GB)

(21) Appl. No.: 17/926,196

(22) PCT Filed: Jun. 10, 2021
(86) PCT No.: PCT/US2021/036733

§ 371 Date: Nov. 18, 2022

Related U.S. Application Data
(60) Provisional application No. 63/041,299, filed on Jun. 19, 2020.

(51) Int. Cl. H01F 27/06; H01F 27/28

(52) U.S. Cl. CPC H01F 27/06; H01F 27/2895; H01F 27/2823; H01F 2027/065; H01F 27/022

(57) ABSTRACT

A pin has a z shape and includes a first notch in a first tip of the pin and a first slot in a first bend in the pin. Alternatively, a pin includes first, second, and third plates; a first bend connecting the first and the second plates; a second bend connecting the second and the third plates. The first plate includes a first notch, and the second bend includes a first slot. A module includes a substrate, a pin mounted to the substrate, and a wire wound around the pin.

### CROSS REFERENCE TO RELATED APPLICATIONS

This application claims the benefit of U.S. Provisional Patent Application No. 63/041,299 filed on Jun. 19, 2020. The entire contents of this application are hereby incorporated by reference.

In addition, U.S. Provisional Patent Application No. 63/041,438 filed on Jun. 19, 2020; and U.S. Provisional Patent Application No. 63/041,435 filed on Jun. 19, 2020 are hereby incorporated by reference.

### BACKGROUND OF THE INVENTION

### 1. Field of the Invention

The present invention relates to a z-shaped pin. More specifically, the present invention relates to a z-shaped pin that can be surface mounted to a substrate and around which wires can be wrapped.

### 2. Description of the Related Art

FIG. 1 shows a known transformer assembly 100 that includes a core cup 101 and primary and secondary windings 102, 103 wound around the core cup 101. FIG. 2 shows an electronic assembly 120 that includes the transformer assembly 100 mounted to a printed circuit board (PCB) 110. Terminals 112 are connected to the PCB 110. The terminals 112 are edge mounted to the PCB 110 and can be used to connect the electronic assembly 120 to a host PCB (not shown). The primary and secondary windings 102, 103 can be attached to pads 111 on the PCB 110. In FIG. 2, for simplicity, only one of the primary or secondary windings 102 or 103 is shown. The primary and the secondary windings 102, 103 are hand-soldered to the pads 111 on the PCB 110, and such hand-soldered portions are not reliable over long-term thermal cycling tests.

### SUMMARY OF THE INVENTION

To overcome the problems described above, preferred embodiments of the present invention provide surface mounted pins that can have a z-shape and around which wires can be wrapped and soldered thereto. The wires can be soldered to the z-shaped pin without hand soldering.

According to a preferred embodiment of the present invention, a pin has a z shape and includes a first notch in a first tip of the pin and a first slot in a first bend in the pin.

A second notch can be in a second tip of the pin, and a second slot can be in a second bend in the pin.

According to a preferred embodiment of the present invention, a pin includes first, second, and third plates; a first bend connecting the first and the second plates; a second bend connecting the second and the third plates. The first plate includes a first notch, and the second bend includes a first slot.

The second bend can include a second slot, and the third plate can include a second notch. The first and the second plates can be parallel or substantially parallel.

According to a preferred embodiment of the present invention, a module includes a substrate, a pin according to one of the various preferred embodiments of the present invention mounted to the substrate, and a wire wound around the pin.

The module can further include a transformer, wherein the wire can be a winding of the transformer. The module can further include an additional pin, wherein the wire can be wound around the additional pin. The wire can be wound around the first bend, through the first slot, and through the first notch. The wire can be soldered to the pin. The module can further include a casing that surrounds the substrate.

The above and other features, elements, characteristics, steps, and advantages of the present invention will become more apparent from the following detailed description of preferred embodiments of the present invention with reference to the attached drawings.

### BRIEF DESCRIPTION OF THE DRAWINGS

FIG. 1 shows a known core cup with windings wound around the core cup.

FIG. 2 shows a known core attached to a printed circuit board with the windings soldered to the printed circuit board.

FIGS. 3 and 4 are perspective views of a z-shaped pin.

FIG. 5 is a side view of the z-shaped pin.

FIG. 6 is a top view of the z-shaped pin.

FIGS. 7 and 8 are perspective views showing a winding of a transformer connected two z-shaped pins.

FIG. 9 is a perspective view showing a wire wrapped around a z-shaped pin.

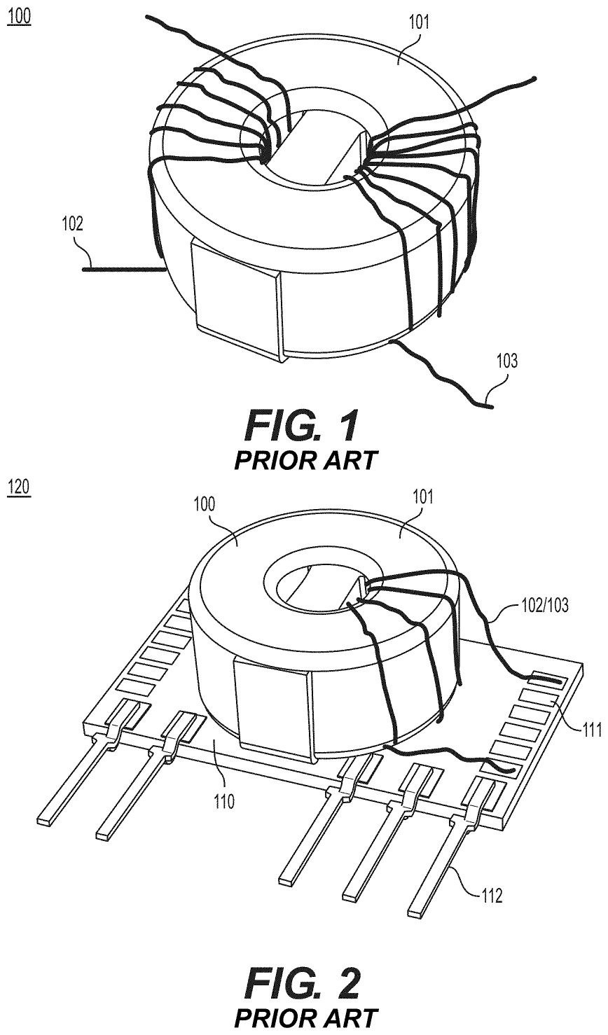

### DETAILED DESCRIPTION OF PREFERRED EMBODIMENTS

The following description is in all aspects illustrative and not restrictive and should not be construed to restrict the applications or uses of preferred embodiments of the present invention in any manner.

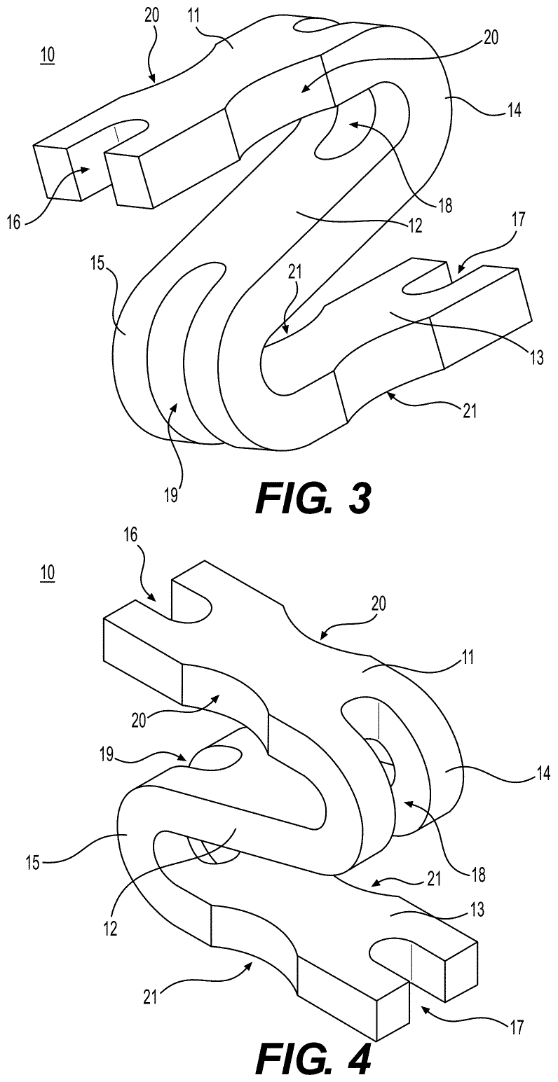

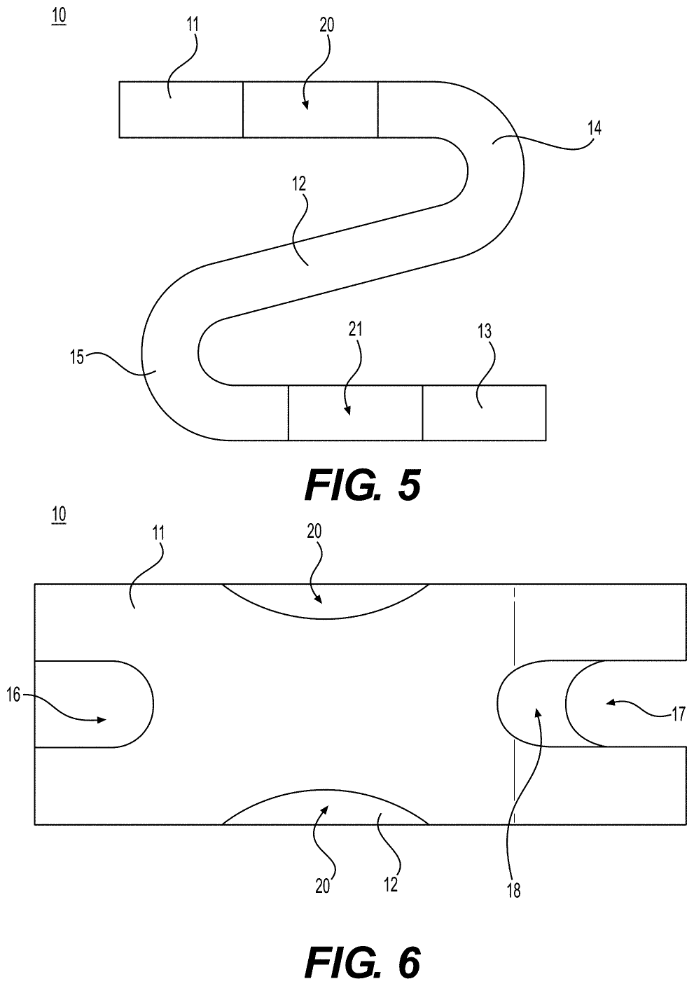

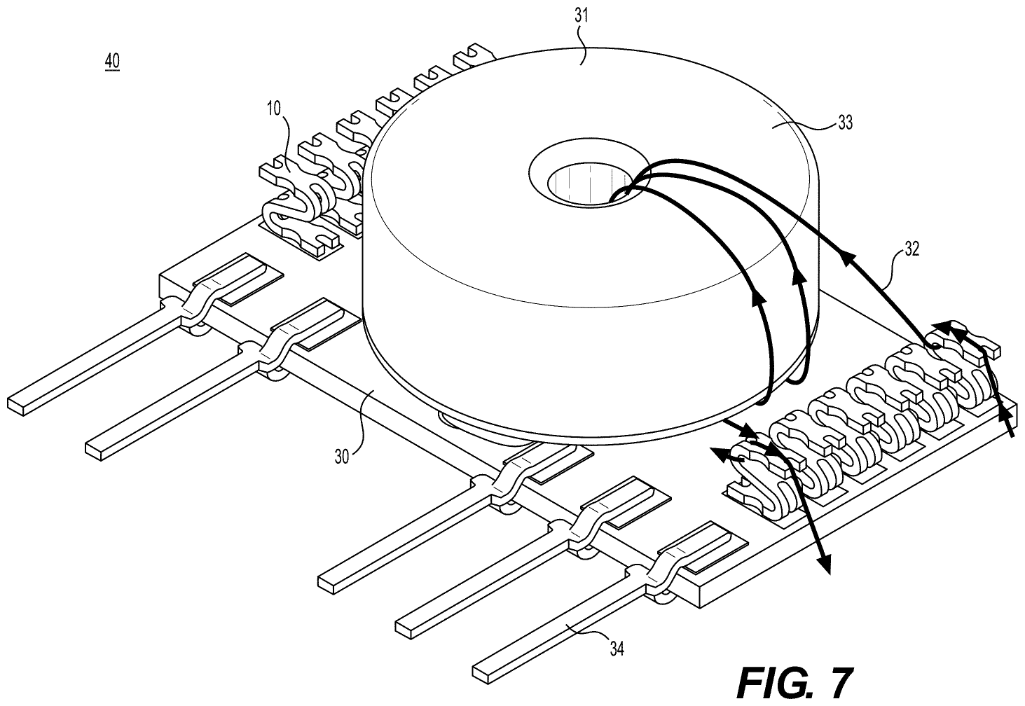

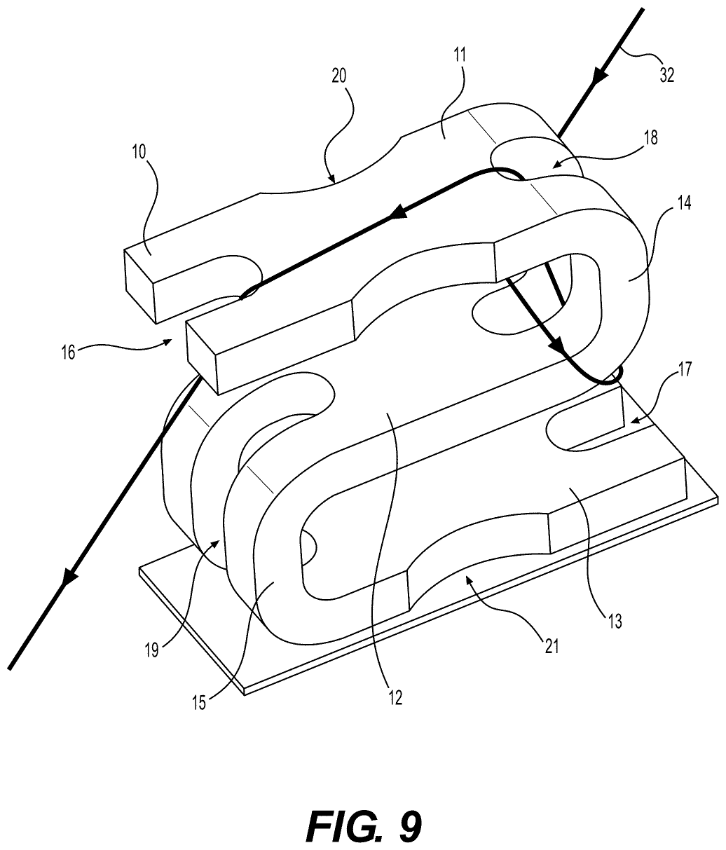

FIGS. 3-6 and 9 show a pin 10 with a z-shape. The pin 10 can be made by any suitable method, including, for example, stamping a base metal sheet. The pin 10 can be made of any suitable metallic material, including, for example, copper with a nickel/tin finish. The shape of the pin 10 can also be referred to as s-shaped. The pin 10 includes three plates 11, 12, 13 connected by two bends 14 and 15. As shown in FIGS. 3 and 4, the plates 11, 13 can be parallel or substantially parallel within manufacturing tolerances, and the plate 12 can be tilted at an angle with respect to the plates 11, 13. Alternatively, none of the plates 11, 12, 13 can be parallel or substantially parallel. For example, the bend 14 connecting plates 11, 12 can be greater than what is shown in FIGS. 3 and 4 so that the plate 11 is no longer parallel with the plate 13, which might hinder or prevent the pin 10 from being used with a pick-and-place machine. Or the bends 14, 15 can be set so that each of the plates 11, 12, 13 is parallel or substantially parallel within manufacturing tolerances with each other, as shown in FIG. 9. As shown in FIGS. 3-6, the pin 10 can be symmetrical about a plane through the center of the pin 10 and parallel to the plates 11, 13 so that either plate 11 or 13 can be mounted to a substrate. Additional, a symmetrical pin 10 can make taping and reeling easier and/or cheaper. Alternatively, the pin 10 can be asymmetrical so that only one of the plates 11 or 13 is intended to be mounted to a substrate. The plate 11 or 13 can provide a flat surface so that a pick-and-place machine can pick up and place the pin 10 on a substrate, as shown in FIG. 7. The pin 10 is picked and placed into solder paste on a substrate, after which the substrate goes through a reflow oven which reflows the solder paste and makes a solder joint between the pins 10 and the substrate at the same time. Laser soldering could then be used to solder a winding to the top plate 11 without affecting the solder joint between the pin 10 and the substrate. The substrate can be a portion of a mother substrate that includes an array of substrates, which can later be separated into separate substrates. Alternatively, the winding can be welded to the top plate 11.

As shown in FIGS. 3-6, the tip of plate 11 can include notch 16, and the top of plate 13 can include notch 17. The notches 16 and 17 can have any suitable shape or length. As shown in FIGS. 3 and 4, the tips of the pin 10 can both include a notch 16 or 17 so that either the plate 11 or the plate 13 can be connected to a substrate. That is, the pin 10 can be symmetrical about a plane passing through the center of the pin 10 parallel to the two plates 11, 13. Alternatively, only of one the plates 11 or 13 can include a notch 16 or 17 so that plate 13 or 11 without the notch can be mounted to a substrate.

The bend 14 can include slot 18, and the bend 15 can include slot 19. The slots 18 and 19 can have any suitable shape or length. As shown in FIGS. 3 and 4, each of the bends 14 and 15 can include a slot 18 and 19 so that either the plate 11 or the plate 13 can be connected to a substrate. That is, the pin 10 can be symmetrical about a plane passing through the center of the pin 10 and parallel to the two plates 11, 13. Alternatively, only of one the bends 14 or 15 can include a slot 18 or 19 so that plate 13 connected to bend 15 or the plate 11 connected to bend 14 without the notch can be mounted to a substrate.

The plate 11 can also include two side notches 20, and the plate 13 can include two side notches 21. The plates 11, 13 can include any number of side notches. For example, the plates 11, 13 could each include only a single notch. The side notches 20 and 21 can have any suitable shape or length. As shown in FIGS. 3 and 4, each of the plates 11 and 13 can include two side notches 20 or 21 so that either the plate 11 or the plate 13 can be connected to a substrate. The side notches 20 or 21 and the notches 16 or 17 of the plate 11 or 13 mounted to a substrate allows the solder land or pad on the substrate to be smaller than if no side notches 20 or 21 and notches 16 or 17 were used. A smaller solder land or pad in turn allows for the pins 10 to be pick-and-placed on a smaller pitch. The outer dimension of the solder lands or pads can be greater than the outer dimension of the plate 11 or 13 to allow a suitable solder fillet to be formed. The side notches 20 or 21 and notches 16 or 17 allow solder fillets to be created within the outer profile of the pin 10. The pin 10 can be symmetrical about a plane passing through the center of the pin 10 and parallel to the two plates 11, 13. Alternatively, only one of the plates 11 or 13 can include two side notches 20 or 21 so that the plate 13 or the plate 11 without the notches can be mounted to a substrate.

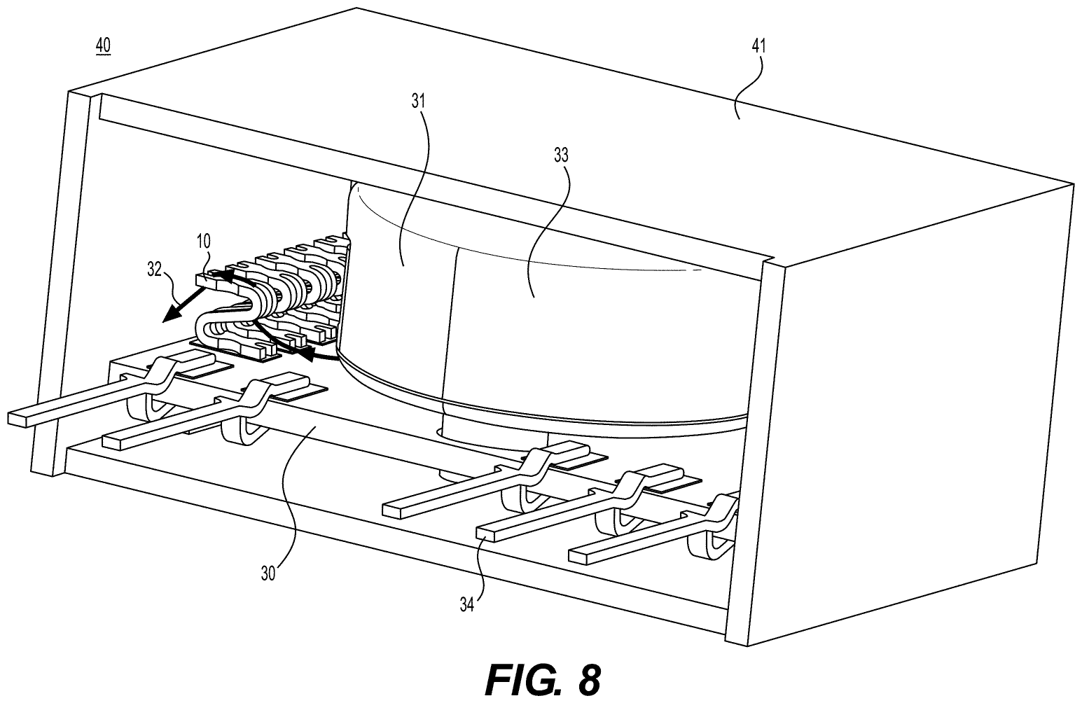

FIG. 7 shows a module 40 including a substrate 30, terminals 34, transformer 31, a first row of six pins 10 arranged along one side of a substrate 30, and a second row of six pins 10 arranged along another side of the substrate 30. FIG. 8 shows the module 40 with a casing 41. The module 40 can be any type of module, including those disclosed in the two U.S. Provisional Patent Applications: Lee Francis et al., “ENCLOSURE FOR ISOLATING TRANSFORMER CORE FROM WINDINGS,” U.S. Provisional Patent Application No. 63/041,435, filed on Jun. 19, 2020; and Lee Francis et al., “ENCLOSURE FOR ISOLATING TRANSFORMER CORE FROM WINDINGS,” U.S. Provisional Patent Application No. 63/041,438, filed on Jun. 19, 2020.

The substrate 30 can be a PCB or any other suitable substrate. Although not shown in FIGS. 7 and 8, electrical components can be attached to the substrate 30 opposite to the transformer. For example, if the module 40 is a converter, then the electrical components can be the electrical components of a converter, including, for example, active components such as power switches and synchronous rectifiers and passive components such as resistors, capacitors, inductors, and diodes.

Terminals 34 can be attached to the substrate 30 and can be used to attach the module 40 to another device, e.g., a host substrate or PCB (not shown). FIGS. 7 and 8 show five terminals 34, but any number of terminals can be used. Terminals 34 can be edge-fit pins that fit on the edge of the substrate 30. Other suitable types of terminals can also be used.

The transformer 31 can be attached to the substrate 30 in any suitable manner. For simplicity, in FIGS. 7 and 8, the transformer 31 is shown with only one winding 32 wound around the core 33. The winding 32 can be an insulated copper wire, but any other suitable wire can be used. The insulation of the wire can be removed so that the winding 32 can be attached to the pin 10. The insulation of the wire can be removed before the winding 32 is attached to the pin 10. Alternatively, in some circumstances, the insulation might be removed during the same process as the winding 32 being soldered or welded to the pin 10. Additional windings, including primary and auxiliary windings, can be used. Also, although not shown in FIG. 7, the windings can include more than two terminations that need to be connected to the substrate. FIG. 7 shows that the winding 32 includes three turns, but any number of turns can be used.

FIG. 7 shows first and second rows of pins 10 arranged along different sides of the substrate 30. It is possible to use different numbers and/or different arrangements of pins. For example, six pins 10 can be arranged on a primary side of the transformer 31 to provide starting, center-tap, and ending connections for both primary and auxiliary windings, and three pins 10 can be arranged on a secondary side of the transformer 31 to provide starting, center-tap, and ending connections for a secondary winding. Instead of having a single row of six pins 10, two rows of three pins 10 could also be used. The pitch of the pins 10 on the substrate 30 can be about 1.27 mm, but other pitches are also possible. The smaller the pitch, the smaller the module 40 can be made. The two rows of pins 10 can have different pitches. For example, if there are six pins 10 in the row on the primary side and if there are three pins 10 in the row on the secondary side, then the pins 10 in the row on the primary side can have a 1.27-mm pitch, and the pins 10 in the row on the secondary side can have a 2.54-mm pitch. Alternatively, the pins 10 can be placed individually around the substrate 30.

FIG. 7 shows the winding 32 of the transformer 31 wrapped around two pins 10, and FIG. 8 shows another winding 32 wrapped around a single pin 10. For simplicity, the winding 32 shown in FIG. 7 is not center-tapped, so the winding 32 is wrapped around only two pins 10. If the winding 32 is center-tapped, then the winding 32 can be wrapped around a third pin 10. Alternatively, the winding 32 can include two wires each being wrapped around two pins 10 for a total four pins 10, and two of the pins 10 can be directly electrically connected on or within the substrate 30 to define a center tap of the winding 32. The winding 32 can be wrapped around the pin 10 such that there is no tension in the winding 32 between the pin 10 and the transformer 31.

Although FIGS. 7 and 8 show the pin 10 being used with a transformer, the pin 10 can be used with any other device that includes a wire that needs to be connected to a substrate. That is, any type of suitable wire can be wound around the pin 10.

FIG. 9 shows a possible winding arrangement of the winding 32. In FIG. 9, the winding 32 is wrapped around the bend 14, through the slot 18, and into the notch 16 so that the winding 32 extends along the top surface of the plate 11. Other winding arrangements are also possible. The winding 32 can be soldered to the plate 11. For example, the pin 10 can be solder-dipped to make soldering the wire easier. The winding 32 can be soldered to the pin 10 by hand or can be soldered using, for example, laser soldering or wave soldering, which can be automated.

It should be understood that the foregoing description is only illustrative of the present invention. Various alternatives and modifications can be devised by those skilled in the art without departing from the present invention. Accordingly, the present invention is intended to embrace all such alternatives, modifications, and variances that fall within the scope of the appended claims.

1. A pin having a z shape and including a first notch in a first tip of the pin and a first slot in a first bend in the pin.

2. The pin of claim 1, wherein a second notch is in a second tip of the pin, and a second slot is in a second bend in the pin.

3. A pin comprising:
first, second, and third plates;
a first bend connecting the first and the second plates;
a second bend connecting the second and the third plates; wherein
the first plate includes a first notch; and
the second bend includes a first slot.

4. The pin of claim 3, wherein
the second bend includes a second slot; and
the third plate includes a second notch.

5. The pin of claim 3, wherein the first and the second plates are parallel or substantially parallel.

6. A module comprising:
a substrate;
the pin of claim 1 mounted to the substrate; and
a wire wound around the pin.

7. The module of claim 6, further comprising a transformer;
wherein the wire is a winding of the transformer.

8. The module of claim 7, further comprising an additional pin;
wherein the wire is wound around the additional pin.

9. The module of one of claim 6, wherein the wire is wound around the first bend, through the first slot, and through the first notch.

10. The module of claim 6, wherein the wire is soldered to the pin.

11. The module of claim 6, further comprising a casing that surrounds the substrate.
